(19) United States
(12) Patent Application Publication
(10) Pub. No.: US 2002/0000050 A1
(43) Pub. Date: Jan. 3, 2002

(54) Apparatus for and process of drying articles

(76) Inventor: Ekhard Goldack, Lemgo (DE)

Correspondence Address: Henry M. Feiereisen, Suite 3220, 350 Fifth Avenue, New York, NY, 10118, US

(21) Appl. No.: 09/792,886

(22) Filed: Feb. 23, 2001

(30) Foreign Application Priority Data
Feb. 24, 2000 (DE) 100 08 750.7

(51) Int. Cl. F26B 3/00

(52) U.S. Cl. 34/444

(57) ABSTRACT

Articles to be dried are fed in a drying chamber to a first carrier element which is moved incrementally in a vertical direction. A subsequent second carrier element with a further article to be dried is then stacked underneath the first carrier element, with the stack of carrier elements is moved incrementally in vertical direction. Each carrier element with provided with a transport mechanism for receiving articles to be dried and discharging dried articles, whereby an aeration system circulates warm drying air through the drying chamber. The carrier elements are stacked on one another, whereby a lifting device is configured for moving the stack in vertical direction.

### CROSS-REFERENCES TO RELATED APPLICATIONS

This application claims the priority of German Patent Application Serial No. 100 08 750.7, filed Feb. 24, 2000, the subject matter of which is incorporated herein by reference.

### BACKGROUND OF THE INVENTION

The present invention relates, in general, to an apparatus for and process of drying articles.

It is known to transport articles, e.g. pieces of furniture coated with varnish, lacquer or paint or bricks, painted sheets etc., by means of a conveyor belt through a tunnel, in which drying air is circulated. Once moved through the tunnel, the articles can be used for further processing at the other end of the tunnel. As relatively high transport speeds are increasingly demanded, the drying times in the tunnel dryer become either short, or the tunnel dryer has to be desired sufficiently long to provide suitable drying times, which means that the overall costs become prohibitively high.

German Pat. No. DE 36 32 740 describes a dryer for the treatment of articles coated with e.g. varnish, lacquer, paint, etc, which includes in the drying chamber a transport system of the paternoster type. The transport system includes several tray-like carriers for support of the articles. The carriers are moved by a chain incrementally upwards, to the side and subsequently downwards. In the lower region, the carriers are moved laterally back again so that each carrier moves through a drying cycle. This conventional dryer suffers shortcomings because drying air flows between individual carriers so that a desired temperature distribution of the circulating drying air cannot be established. Rather heat accumulates in the upper region of the drying chamber so that depending on the maximum temperature a certain temperature profile is formed across the height of the drying chamber. However, oftentimes there is a need for drying in the lower region of the drying chamber at a lower temperature in order to effect a drying action through the entire article and thus to prevent a mere surface drying. Only afterwards is it desired to apply a high temperature for realizing a drying action so as to effect a hardening. This conventional dryer is unsuitable to implement a temperature control in this manner. Another problem is wear of the employed chain guides of the paternoster mechanism and a resultant need for regular maintenance work that requires a shutdown of the entire apparatus. This is cumbersome and expensive as far as overall operating costs are concerned.

It would therefore be desirable and advantageous to provide an improved process and apparatus, obviating prior art shortcomings and effective to realize long retention times of the articles in the drying chamber while yet allowing a transport of the articles in a simple manner, without requiring significant maintenance work.

### SUMMARY OF THE INVENTION

According to one aspect, the present invention provides for a drying process including a drying chamber in which drying air is circulated and in which the articles to be dried are fed onto a first carrier element which is then moved step-by-step in a vertical direction, while a second carrier element with an article to be dried is stacked directly underneath or above the first carrier element, and the stack of carrier elements is then moved stepwise in a vertical direction.

By stacking the carrier elements through either positioning a carrier element upon or underneath a carrier element of a stack of carrier elements and moving the stack incrementally in vertical direction, the need for mechanical conveyors such as chains, belts or other transport devices that require regular maintenance works, is eliminated. The carrier elements can easily be stacked, thereby reducing the complexity of the transport mechanism. Further, as a consequence of a stacked arrangement of the carrier elements, there is no spacing between the carrier elements for escape of warm drying air so that the apparatus operates energy-efficient and allows a desired temperature profile in the drying chamber.

In accordance with a preferred embodiment of the present invention, the second carrier element is moved underneath the first carrier element and the stack of carrier elements is elevated by a lifting device. Such a stack configuration in the drying chamber allows supply of articles to be dried in the lower zone and a subsequent movement of the carrier elements upwards so that the lower zone of the stack can be utilized as pre-heating phase with a temperature that is cooler than in the upper zone. To ensure a uniform height of the stack of carrier elements, an uppermost carrier element of the stack is removed to the side each time the stack is elevated. Suitably, the uppermost carrier element is deposited on a neighboring second stack of carrier elements so that the carrier elements advance through a drying cycle.

To implement such a drying cycle of the carrier elements while yet using minimum transport elements, the lifting device can be so configured to move a lowermost carrier element from the neighboring second stack underneath the first stack, with dry articles being removed from this carrier element and new articles to be dried being fed. Subsequently, the carrier element is stacked again underneath the lowermost carrier element of the first stack. The lifting device can thereby effectively be used to move and rearrange carrier elements between the neighboring stacks.

According to another aspect of the present invention, a drying apparatus includes a drying chamber, an aerating mechanism for circulating warm drying air in the drying chamber, a stack of superimposed carrier elements accommodated in the drying chamber and adapted for receiving articles to be dried, a lifting device for moving the stack of carrier elements in a vertical direction, and a transport device configured for feeding articles to be dried to the carrier elements and receiving dried articles from the carrier elements.

When stacking the carrier elements with the articles to be dried in the drying chamber and moving the stack of carrier elements by the lifting device in a vertical direction, the use of circulating transport chains or similar power-transmitting devices can be eliminated. As a result, maintenance works are reduced to a minimum, and the aeration of the articles with a desired temperature profile can be enhanced in view of the stacked superimposed arrangement of the carrier elements that leaves at most only small openings between the carrier elements.

According to another feature of the present invention, the stack of carrier elements is secured in position by a catch mechanism. An example of such a catch mechanism includes catches that engage in complementary recesses or other latching configurations of the carrier elements. As the stack of carrier elements may have a fairly substantial weight, the catch mechanism is so configured to engage the stack of carrier elements at least at four locations to better distribute the weight force. The catches may be moveable linearly towards and away from the carrier elements, or each catch may include a swing mechanism.

According to another feature of the present invention, each of the carrier elements has sidewalls in parallel relationship to a feed direction of articles to be dried, with the carrier elements stacked directly on the sidewalls. In this manner, a sealed conduction of the drying air is realized in parallel relationship to the sidewalls so that a targeted air stream can migrate into the hollow space between two carrier elements. As a result, the temperature profile in the stack can be accurately controlled. It is possible, to subdivide the stack of carrier elements in aeration zones with different temperature.

According to another feature of the present invention, a second stack of carrier elements is accommodated in the drying chamber in neighboring relationship to the first stack of carrier elements, whereby the single carrier elements move through a drying cycle through the drying chamber. In this way, the articles can be retained in the drying chamber over a long period while at the same time the demand for space is minimized. Suitably, the drying chamber may include in an upper area of the first and second stack of carrier elements a gantry for transferring an uppermost carrier element from one stack onto an uppermost carrier element of the other stack of carrier elements.

According to another feature of the present invention, a lowermost carrier element of one stack can be transferred to a position underneath a lowermost carrier element of the other stack through synchronized operation of the lifting device and the catch mechanism. Thus, the individual carrier elements can be moved in increments, without any need for complicated conveying devices.

Suitably, the sidewalls of the carrier elements are heat-insulated.

According to another feature of the present invention, each of the carrier elements has centering elements on one side and pockets on an opposite side to allow engagement to a superimposed one of the carrier elements and attachment of an subjacent one of the carrier elements. In this way, great stacking heights without additional guide elements can be realized.

### BRIEF DESCRIPTION OF THE DRAWING

Other features and advantages of the present invention will be more readily apparent upon reading the following description of preferred exemplified embodiments of the invention with reference to the accompanying drawing, in which:

FIG. 1 is a schematic sectional side view of a first embodiment of a drying apparatus according to the present invention;

FIG. 2 is a front view of the drying apparatus of FIG. 1;

FIG. 3 is a top view of the drying apparatus of FIG. 1;

FIG. 4 is a detailed illustration of a carrier element for use in the drying apparatus of FIG. 1;

FIG. 5 is a sectional side view of the carrier element of FIG. 4;

FIG. 6 is a cutaway view, on an enlarged scale, of one variation of a catching mechanism for latching onto a carrier element;

FIG. 7 is a cutaway view, on an enlarged scale, of another variation of a catching mechanism for latching onto a carrier element;

FIG. 8A is a schematic side view of a second embodiment of a drying apparatus according to the present invention;

FIG. 8B is a top view of the drying apparatus of FIG. 8A; and

FIG. 9 is a schematic side view of a third embodiment of a drying apparatus according to the present invention.

### DETAILED DESCRIPTION OF PREFERRED EMBODIMENTS

Throughout all the Figures, same or corresponding elements are generally indicated by same reference numerals.

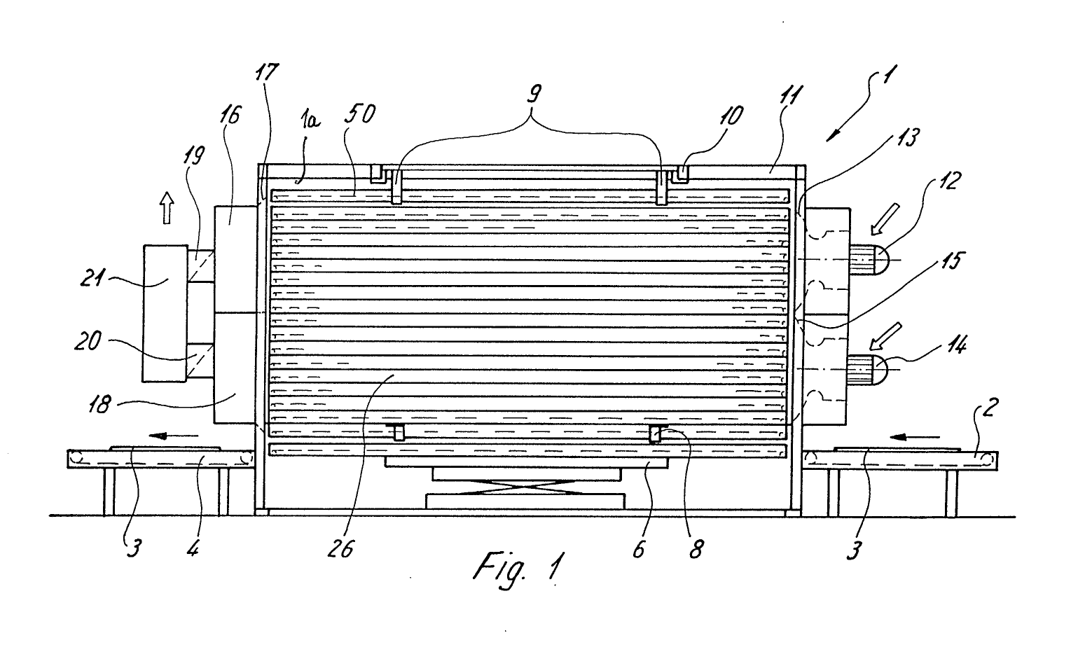

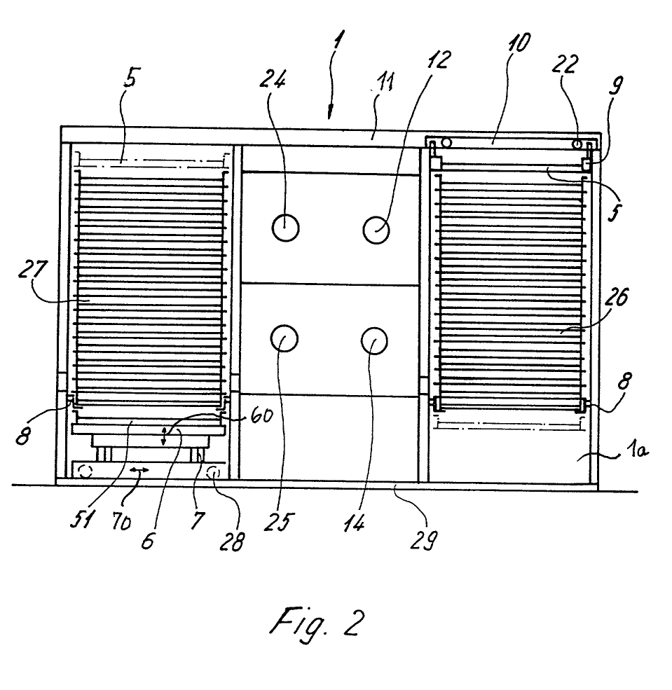

Turning now to the drawing, and in particular to FIG. 1, there is shown a schematic sectional side view of a first embodiment of a drying apparatus according to the present invention, generally designated by reference numeral 1. The drying apparatus 1 includes a drying chamber 1a which accommodates a first stack 26 of a plurality of superimposed carrier elements 5 and a second stack 27 of a plurality of superimposed carrier elements 5 in side-by-side disposition, as shown in FIG. 2. Disposed anteriorly of the drying chamber 1a is a feed unit in the form of a transport band 2 for supply of articles 3 to be dried. On the opposite side of the drying chamber 1a is a transport unit 4 for moving dried articles 3 away to a subsequent, not shown, processing station.

Positioned upon the bottom of the drying chamber 1a is a lifting device in the form of a lifting platform 6 which can be adjusted in a vertical direction, indicated by double arrow 60, by a pantographic linkage 7. The lifting platform 6 is supported on rollers 28 which are guided in rails 29 so as to allow a travel of the lifting platform 6 in a direction of double arrow 70 between the stacks 26, 27. Thence, the lifting platform 6 can be positioned underneath each of the stacks 26, 27 to lift or lower the entire stacks, respectively, as will be described furtherbelow.

As shown in FIG. 4, each carrier element 5 includes a conveyor belt 33 which should be made of a material that is capable to withstand temperatures of preferably up to 200° C. Suitably materials for the conveyor belt 33 include textile material, plastic, sheet metal or a link chain. The conveyor belt 33 is trained about a belt-reversing roller 34 and a spring-mounted tension roller 35 spaced from one another in a direction transversely to a transport direction of the articles 3, indicated by arrow 90. The belt-reversing roller 34 is driven via a gear 43 by a, not shown, drive mechanism and rotatably supported in parallel sidewalls 31 which are sized to extend beyond the conveyor belt 33, as shown in FIG. 5. The tension roller 35 is also rotatably supported by the sidewalls 31. Disposed underneath the conveyor belt 33 is a table-like backing 37 which has a sliding surface to support the conveyor belt 33 and thereby prevent a sagging thereof. Additional support rollers 36 are provided in a central location below the conveyor belt 33.

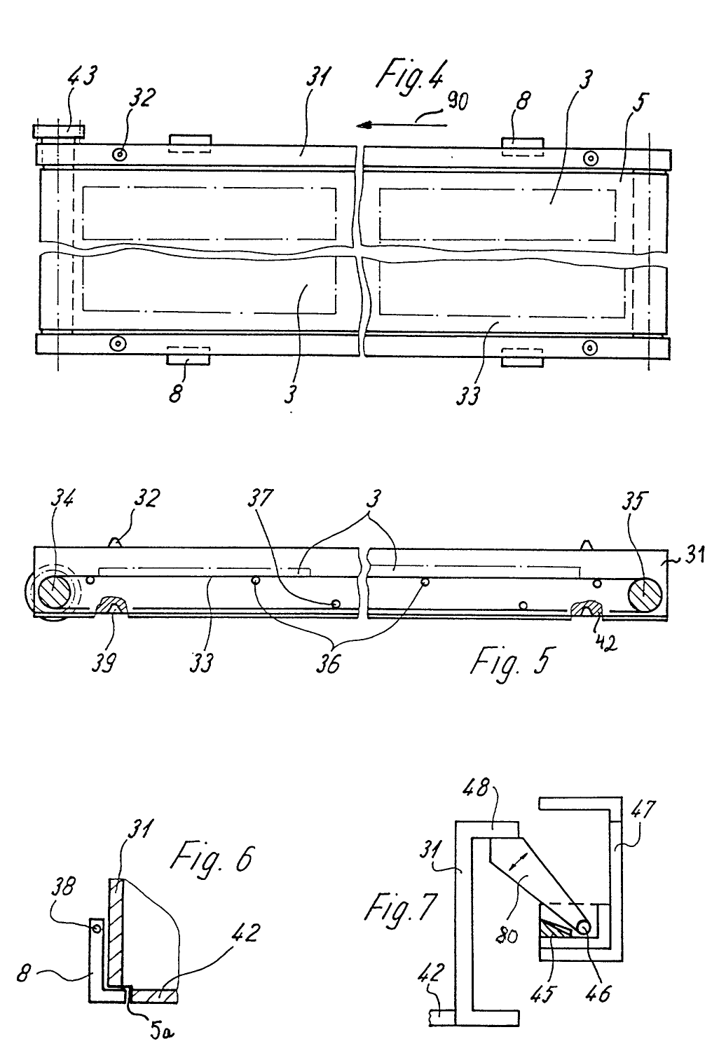

Each of the stacks 26, 27 is held in place in the drying chamber 1a by a separate catch mechanism which includes at least four catches 8 configured for latching onto the carrier element 5 that is in lowermost position at a given time. As shown in FIG. 6, each sidewall 31 of the carrier elements 5 is connected integrally with a bottom 42, with a recess 5a formed at a junction between the sidewall 31 and the bottom 42 for engagement of a one of the catches 8. Of course, the number of recesses 5a of each carrier element 5 corresponds to the number of catches 8, i.e. in the nonlimiting example of FIG. 1 four catches 8 engage in four recesses 5a. The catches 8 are each swingably mounted for rotation about a pivot axis 38 so that the catches 8 can disengage from the respective carrier element when the stack of carrier elements is slightly elevated by the lifting platform 6. As an alternative, the catches may also be configured for linear movement to the outside.

The vertical extension of the sidewalls 31 is so sized that the space between the bottom 42 of the carrier elements 5 and the conveyor belt 33 of the subjacent carrier element 5 is sufficient for receiving articles 3 to be dried. As shown in FIG. 5, each carrier element 5 has conical centering pins 32, which project out from the sidewalls 31, and pockets 39 are formed in the bottom 42. Thus, through engagement of the centering pins 32 of one carrier element 5 in pockets 39 of a superimposed carrier element 5, an exact positioning of the carrier elements 5 in superimposed disposition can be realized.

Disposed in the upper region of the drying chamber 1 is a gantry 10 which is mounted to and movable along a guide rail 11 by rollers 22. The gantry 10 includes four grippers 9 by which an uppermost one of the carrier elements 5 of the first stack 26 can be lifted and moved sideways, as another carrier element 5 is moved by the lifting unit 6 underneath a lowermost carrier element 5 of the stack 26. In the nonlimiting example of FIG. 1 with two stacks 26, 27, the grippers 9 move an uppermost one of the carrier elements 5 of the first stack 26 sideways to deposit this carrier element 5 atop the uppermost one of the carrier elements 5 of the stack 27, as indicated in FIG. 2 by dashdot line, while the lifting platform 6 moves sideways underneath the stack 26 to transfer the lowermost carrier element 5 to a position underneath the stack 26.

Persons skilled in the art will understand that the provision of four grippers 9 is done by way of example only, as the arrangement of more than four grippers is certainly conceivable and covered within the scope of the present invention.

The drying chamber 1a is aerated by a first fan 12 in the upper zone of the stack 26 and by a second fan 14 in the lower zone of the stack 26. The fans 12, 14 are each equipped with a, not shown, filter and a, not shown, heater, e.g., heat exchanger or heating coil so that pure air can be used for drying the articles 3. A subdivision of the stack 26 into drying zones with different temperature can be implemented through provision of a baffle 13 positioned downstream of and interacting with the fan 12 and a baffle 15 positioned downstream of and interacting with the fan 14 so that the airstream through the hollows between the carrier elements 5 can be accurately controlled as a function of the temperature, the volume stream and the flow speed. Disposed on the opposite side of the drying chamber 1a is an upper aeration chamber 16 and a lower aeration chamber 18 which connect, respectively, in vent channels 19, 20 that terminate in a chimney 21.

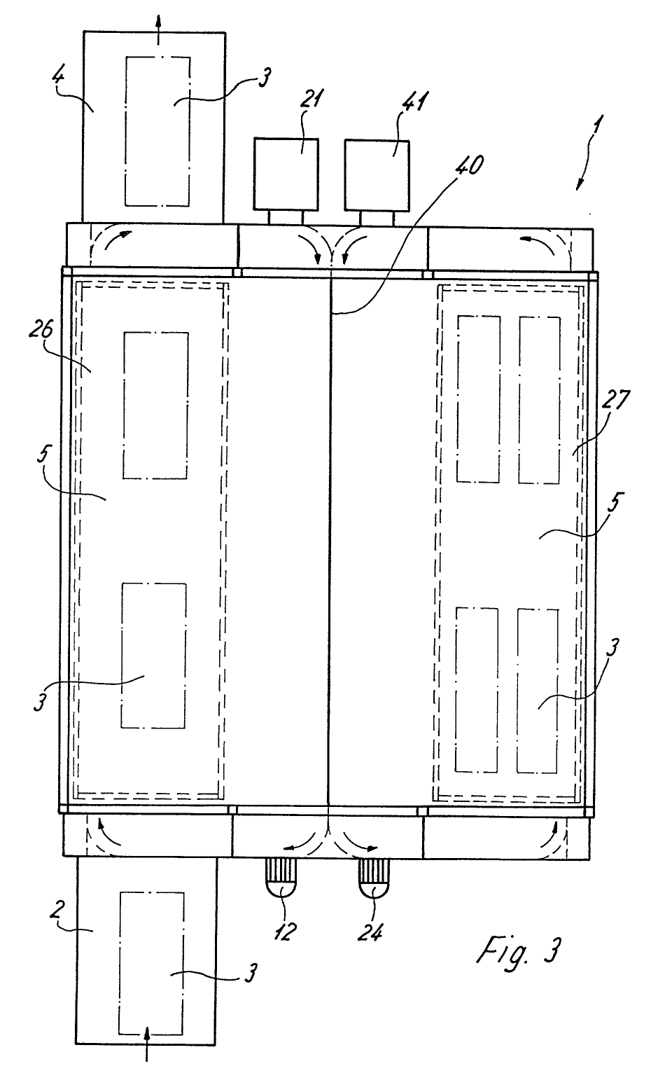

Aeration of the second stack 27 is executed in a similar manner with an upper fan 24 and a lower fan 25 (FIG. 5) and a chimney 41 arranged on the opposite side (FIG. 3). The stacks 26, 27 are separated from one another by a partition 40 to thereby provide a total of four aeration zones in which a predetermined temperature can be set. Of course, the size and number of the aeration zones as well as the aeration parameter can be selected in any suitable manner and suited to the situation at hand, e.g. size of the drying chamber.

As an alternative to the aeration system shown in FIGS. 1 to 3, it is also possible to aerate the carrier elements 5 with the articles 3 to be dried through an energy-efficient counterflow process whereby hot air is introduced in an upper region of the stack 26 and conducted through the hollows between the upper carrier elements 5 and subsequently guided through a baffle to a subjacent region. The drying air cools down hereby so that less heat is provided in the lower region of the stack 26. The cooled air is subsequently conveyed via a chimney to the outside. Aeration of the second stack 27 can be carried out in a same direction as the movement of the carrier elements 5 so that higher temperatures are provided in the upper area, whereas the stack 27 is cooled in the lower region. Thus, the carrier elements 5 are not exposed to excessive heat when receiving new articles 3 to be dried.

The operation of the drying apparatus is as follows: The lowermost carrier element 5 of the stack 27, carrying dried articles 3, is lifted by the lifting platform 6 to allow disengagement of the catches 8 which swing outwards. The stack 27 can now be lowered by a distance corresponding to the height of a carrier element 5. The catches 8 are then returned into engagement with the carrier element 5 immediately above the lowermost carrier element 5 to thereby securely hold the stack 27 in place. The lowermost carrier element 5 rests on the lifting platform 6 which moves sideways underneath the stack 26. The dried articles 5 are withdrawn from the carrier element 5 via the conveyor belt of the transport unit 4, and new articles 5 are supplied from conveyor belt 2 of the transport unit 2 onto the now empty carrier element 5. Of course, the conveyor belt 33 is in alignment with the conveyor belts of the transport units 2, 4. The lifting platform 6 underneath the stack 26 moves upwards to slightly elevate the stack 26 and thereby allow disengagement of the catches 8 from the previously lowermost carrier element 5 of the stack 26. The catches 8 are moved outwards, and the lifting platform 6 moves further upwards by a carrier element 5. The catches 8 move again into engagement with the now lowermost carrier element 5 to hold the stack 26 in place. The movement of the lifting platform 6 is synchronized with a movement of the gantry 10. Thus, as the lifting platform 6 raises the stack 26, the uppermost carrier element of the stack 26 is moved sideways and placed on top of the uppermost carrier element 5 of the stack 27. Thus, the carrier elements 5 move incrementally or step-by-step through the drying chamber 1a in a drying cycle to implement a sufficient drying action.

The conveyor belt 33 of the carrier elements 5 is so operated as to run only when the carrier element 5 occupies the lowermost position in the stack 26, at which point the conveyor belt 33 is in alignment with the conveyor belts of the transport units 2, 4. After the catches 8 of the stack 26 engage again the lowermost carrier element in stack 26, the lifting platform 6 is lowered and returned to a position underneath the stack 27 and the gantry 10 is returned to a position above the uppermost carrier element 5 of the stack to repeat the cycle.

Although the preceding description of the drying apparatus is directed to a configuration with two stacks 26, 27, the concept of the present invention as outlined here is also applicable when using only a single stack of carrier elements 5 whereby an uppermost carrier element 5 is moved away by the grippers 9 of the gantry 10 and another carrier element 5 on the lifting platform 6, after loaded with new articles to be dried, is attached to the previously lowermost carrier element 5.

Turning now to FIG. 7, there is shown a variation of a catch mechanism for interaction with a modified configuration of the sidewall 31 of the carrier elements 5. The sidewall 31 of each carrier element 5 has a C-shaped configuration and defines an upper arm 48, and the catch mechanism has a catch 80 which is configured to engage below the arm 48 and swingably mounted in a frame 47 for rotation about a pivot axis 46. A downward deflection of the catch 80 is restricted by a stop 45 mounted interiorly of the frame 47. At operation, when a stack of carrier elements 5, e.g. stack 26, is lowered, the upper arm 48 of the lowermost carrier element 5 impacts upon the catch 80 which, in turn, impacts upon the stop 45. Suitably, a, not shown, spring may pre-load the catch 80 in clockwise direction to ensure that the catch 80 is biased in a direction of engagement.

Although not shown in the drawing, a plurality of such catches 80 may be provided along the sidewall 31 to evenly distribute the load. The catches 80 operate as a ratchet mechanism that allows a movement of the stack upwards while preventing a downward movement of the stack.

When using two stacks 26, 27 for the drying apparatus, the other stack, e.g. stack 27, the catch mechanism may be configured in such a manner that the catches 80 are disengaged from a carrier element long enough to allow lowering of the stack 27 by a carrier element 5. As an alternative, the catch mechanism may also have a controller for controlling the movement of the catches 80.

To realize an energy-efficient configuration, the sidewalls 31 may be lined with an insulation.

In the foregoing embodiments of a drying apparatus according to the present invention, the use of a catch mechanism has been described for holding the stacks 26, 27 in position. Persons skilled in the art will understand that other mechanisms may be possible without departing from the spirit of the present invention. Also, the lifting platform 6 may certainly be replaced by a hydraulic mechanism, positioned under each of the stacks 26, 27 to upwardly move the carrier elements 5. The lateral transfer may also be provided by an additional transport mechanism.

In FIG. 1, the transport unit 2, 4 are shown in linear alignment. It is, however, also possible to arrange the transport unit 4 next to the stack 27 to commence the further transport from this stack 27, so that the transport unit 4 may then be arranged at the same side as the transport unit 2. Moreover, the transport units 2, 4 may be arranged in superimposed disposition in a common frame.

Persons skilled in the art will also understand that the unloading position and loading position of a carrier element 5 may be implemented practically at any location upon the stacks 26, 27. For example, when loading the stack 26 from below, the dry articles 3 can be withdrawn from the respective carrier element 5 from below or any location thereabove. The direction of movement of the carrier elements 5 may also be reversed, for example, when requiring only short drying times.

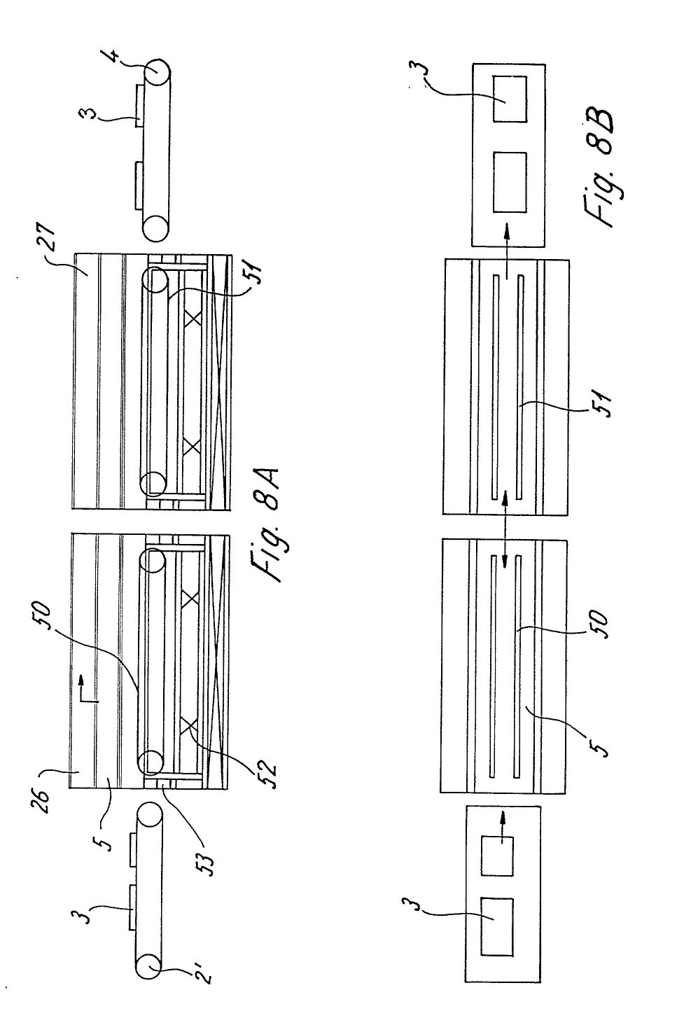

Turning now to FIGS. 8A and 8B, there are shown a second embodiment of a drying apparatus according to the present invention. Parts corresponding with those in FIG. 1 are denoted by identical reference numerals and not explained again. In this embodiment, the carrier elements 5 are devoid of a separate transport unit as the transport of the articles 3 is implemented within the drying chamber 1a via a belt conveyor 50 which projects through slots in the carrier element 5 that is in the lowermost position at any given time. The articles 3 to be dried are conveyed initially by the transport unit 2 into the drying chamber 1a and transferred onto the belt conveyor 50 which projects through the carrier element at the lowermost position of the stack 26. Subsequently, the entire stack 26 is elevated by a vertically adjustable lifting device 52 about the height of a carrier element 5. At the same time the belt conveyor 50 is lowered and the lowermost carrier element 5 of neighboring stack 27 is transferred from a conveyor belt 51 below the stack 27 (FIG. 3) onto the belt conveyor 50 for pickup of new articles to be dried, while the uppermost carrier element on stack 26 is transferred onto the stack 27, e.g., by the grippers of the gantry 10 in the transport direction of the articles 3. Thus, the required width of the drying apparatus is significantly reduced. Although not shown in the drawing, the slots of the carrier elements 5 may be closed by, e.g., sheets, once the carrier elements 5 have left the belt conveyors 50, 51 to thereby enhance the control of the air circulation. The carrier elements 5 in the stack 27 are moved downwards by the lifting device 62, after the lifting device has moved underneath the stack 27, until reaching the belt conveyor 51 for transfer of dried articles 3 to the transport unit 4.

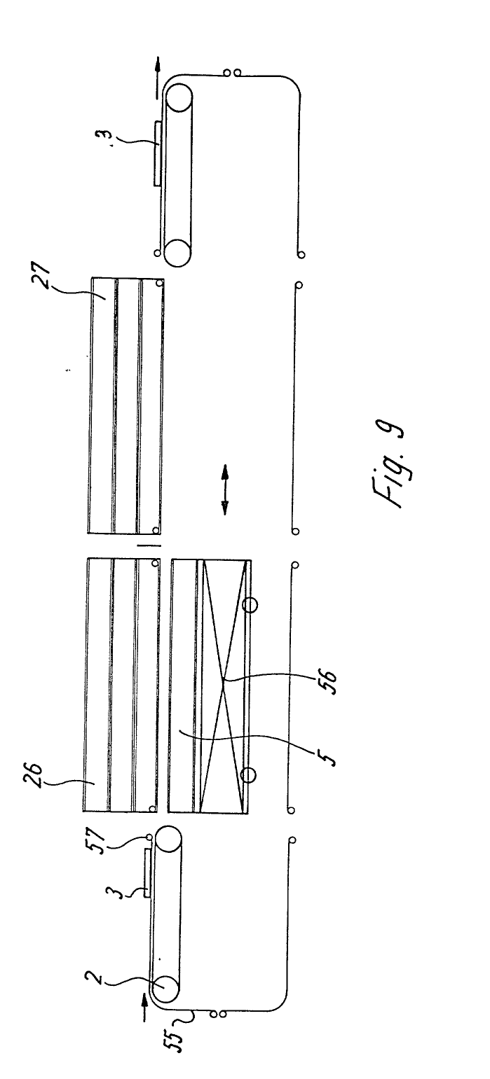

Turning now to FIG. 9, there is shown a third embodiment of a drying apparatus according to the present invention. In this embodiment, provision is made for the arrangement of receiving elements 55 located upstream of the drying chamber 1a between the transport unit 2 and the articles 3 to be dried. Subsequently, the articles 3 are moved together with the receiving element 55 to a carrier element 5 for movement with the stacks 26, 27 in the drying cycle. A lower lifting device in the form of a lift truck 56 is hereby used for travel underneath between the stacks 26, 27 and respective lifting of the stacks 26, 27 in a manner as described above and in conjunction with the upper gantry 10, not shown here. The receiving elements 55 may be provided as flexible band with a rod 57 at the leading end and the trailing end for movement of the receiving elements 55. For example, the receiving element 55 may be transported to a carrier element 5 by a hydraulic mechanism, acting on the leading rod. After leaving the drying cycle, the receiving elements 55 are returned by, not shown, conveyors to the transport unit 2, so as to advance in a loop, as schematically indicated in FIG. 9 by the arrows.

While the invention has been illustrated and described as embodied in an apparatus for and process of drying articles, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A process of drying articles, comprising the steps of:
feeding into the drying chamber an article to be dried onto a first carrier element;
incrementally moving the first carrier element in a vertical direction;
circulating warm drying air in a drying chamber;
stacking a second carrier element with an article to be dried in a manner selected from the group consisting of directly underneath and directly above the first carrier element, to form a stack of carrier elements; and
incrementally moving the stack of carrier elements in a vertical direction.

2. The process of claim 1, wherein the stacking step includes moving the second carrier element directly underneath the first carrier element and elevating the stack of carrier elements by a lifting device.

3. The process of claim 2, and further comprising the steps of removing an uppermost carrier element from the stack of carrier elements every time the stack of carrier elements is elevated; and placing the uppermost element onto a neighboring second stack of carrier elements.

4. The process of claim 3, and further comprising the steps of moving a lowermost carrier element from the second stack of carrier elements underneath a lowermost carrier element of the first stack of carrier elements, withdrawing dried articles from the lowermost carrier element of the second stack of carrier elements; feeding new articles to be dried onto the lowermost carrier element of the second stack of carrier elements; and stacking the lowermost carrier element of the second stack of carrier elements underneath the lowermost carrier element of the first stack of carrier elements.

5. The process of claim 1 for drying varnished pieces of furniture.

6. Apparatus for drying articles, comprising:
a drying chamber;
an aeration system for circulating warm drying air in the drying chamber;
a stack of superimposed carrier elements accommodated in the drying chamber, each said carrier element having a transport mechanism for receiving articles to be dried and transfer of dried articles; and
a lifting device for moving the stack of carrier elements in a vertical direction.

7. The apparatus of claim 6, and further comprising a catch mechanism for securing the stack of carrier elements in position.

8. The apparatus of claim 6, wherein each of the carrier elements has sidewalls in parallel relationship to a feed direction of the articles to be dried, said carrier elements being stacked directly on the sidewalls.

9. The apparatus of claim 8, wherein the aeration system is so operated as to aerate between the sidewalls, with the stack of carrier elements being subdivided in aeration zones of different temperatures.

10. The apparatus of claim 6, and further comprising a second stack of carrier elements accommodated in the drying chamber in neighboring relationship to the first stack of carrier elements, with the first and second stacks of carrier elements moved in a drying cycle through the drying chamber.

11. The apparatus of claim 10, wherein the drying chamber includes in an upper area of the first and second stacks of carrier elements a gantry for transferring an uppermost carrier element of one of the first and second stacks of carrier elements to an uppermost carrier element of the other one of the first and second stacks of carrier elements.

12. The apparatus of claim 7, and further comprising a second stack of carrier elements accommodated in the drying chamber in neighboring relationship to the first stack of carrier elements, wherein a lowermost carrier element of one of the first and second stacks of carrier elements is transferred by the lifting device and the catch mechanism underneath a lowermost carrier element of the other one of the first and second stacks of carrier elements.

13. The apparatus of claim 8, wherein the sidewalls of the carrier elements are heat-insulated.

14. The apparatus of claim 6, wherein the transport mechanism of each of the carrier elements includes a conveyor belt operable to move in a feeding direction and an unloading direction.

15. The apparatus of claim 6, wherein each of the carrier elements has centering elements on one side and pockets on an opposite side to allow engagement to a superimposed one of the carrier elements and engagement of an subjacent one of the carrier elements.

16. The apparatus of claim 7, wherein the catch mechanism includes catches biased in the direction of the carrier elements to latch onto the stack of carrier elements.

17. The apparatus of claim 10, wherein the first and second stacks of carrier elements are arranged behind one another in a transport direction of the articles to be dried.

18. The apparatus of claim 6, and further comprising receiving elements for transfer of the articles to be dried to the carrier elements.

19. A process of drying articles, comprising the steps of:
positioning a carrier element underneath a first stack of superimposed carrier elements in a drying chamber, with each of the carrying elements supporting an article to be dried;
elevating the carrier element by a lifting device to engage from underneath a lowermost carrier element of the stack of carrier elements;
incrementally moving in a vertical direction all stacked carrier elements by a predetermined distance commensurate with a dimension of a carrier element;
circulating drying air through hollows formed between the stacked carrier elements for drying the articles; and
removing an uppermost carrier element from the stack of carrier elements, as the stack of carrier elements is moved incrementally in the vertical direction, for withdrawal of dried articles.

20. The process of claim 19, wherein the elevating step includes disengaging a catch mechanism from the lowermost carrier element of the stack of carrier elements.

21. The process of claim 20, and further comprising the step of engaging the catch mechanism with the stack to secure the stack in place.

22. The process of claim 19, wherein the removing step includes transferring the carrier element to a second stack of superimposed carrier elements.

23. The process of claim 22, wherein the positioning step includes transferring the carrier element from the second stack to the first stack.

24. The process of claim 19, wherein the circulating step includes subdividing the stack of carrier elements in separate aeration zones by circulating drying air at different temperatures through the hollows between the carrier elements in the aeration zones.

25. Apparatus for drying articles, comprising:
a drying chamber;
an aeration system for circulating drying air in the drying chamber;
a first stack of superimposed carrier elements accommodated in the drying chamber and receiving articles to be dried;
a lifting device for incrementally moving the stack of carrier elements in a vertical direction through the drying chamber; and
withdrawal means for removing an uppermost carrier element, carrying dried articles, from the stack, as the stack of carrier elements is moved incrementally in the vertical direction.

26. The apparatus of claim 25, and further comprising a catch mechanism having catches engageable in a one of the carrier elements for securing the stack of carrier elements in position.

27. The apparatus of claim 25, wherein each of the carrier elements has sidewalls in parallel relationship to a feed direction of the articles to be dried, said carrier elements being stacked directly on the sidewalls.

28. The apparatus of claim 27, wherein each of the carrier elements has a bottom formed with a pocket, and a centering pin projecting out from atop the sidewalls for engagement in the pocket of a superimposed carrier element.

29. The apparatus of claim 27, wherein the aeration system is configured for establishing different aeration zones to allow circulation of drying air at different temperatures between the sidewalls of carrier elements in the different aeration zones.

30. The apparatus of claim 25, and further comprising a second stack of carrier elements accommodated in the drying chamber in neighboring relationship to the first stack of carrier elements so that the carrier elements are advanced incrementally in a drying cycle between the first and second stacks.

31. The apparatus of claim 25, wherein the withdrawal means includes a gantry located in an upper area of the drying chamber in overhead relationship to the first stack of carrier elements for removal of the uppermost carrier element.

32. The apparatus of claim 30, wherein the withdrawal means includes a gantry located in an upper area of the drying chamber in overhead relationship to the first and second stack s of carrier elements for removal of the uppermost carrier element onto an uppermost carrier element of the second stack of carrier elements.

33. The apparatus of claim 30, wherein the lifting device is moveable back and forth between locations underneath the first and second stacks of carrier elements for transfer of a lowermost carrier element from the second stack to the first stack.

34. The apparatus of claim 27, wherein each of the carrier elements includes a conveyor belt, secured between the sidewalls, for receiving articles to be dried and discharging dried articles.
